(19) United States
(12) Patent Application Publication
(10) Pub. No.: US 2018/0299606 A1
(43) Pub. Date: Oct. 18, 2018

(54) Apparatus and Methods for Lighting an Ice Rink Using a Light Diffusing Optical Fiber

(71) Applicant: Versalume LLC, Santa Clara, CA (US)

(72) Inventors: Kerry KEATING, San Jose, CA (US); Mario PANICCIA, Santa Clara, CA (US)

(21) Appl. No.: 15/488,787

(22) Filed: Apr. 17, 2017

(51) Int. Cl. F21V 8/00; F21V 33/00; F25C 3/02; A63C 19/10

(52) U.S. Cl. CPC G02B 6/001; F21V 33/008; G02B 6/0229; A63C 19/10; F25C 3/02

(57) ABSTRACT

According to some implementations an ice rink is provided that includes a plurality of coolant tubes that are configured to transport a coolant to cool ice located above the coolant tubes. The ice has a top surface on which ice skating or other activities may occur. An elongate light-diffusing optical fiber is positioned below the top surface of the ice and is configured to transmit light to the top surface of the ice.

### TECHNICAL FIELD

The present disclosure relates to apparatus and methods for lighting a surface of an ice rink or other ice structure.

### SUMMARY OF THE DISCLOSURE

According to some implementations an ice rink is provided that comprises ice disposed above a plurality of coolant tubes, the plurality of coolant tubes being configured to transport a coolant to cool the ice. An elongate light-diffusing optical fiber is positioned inside or below the ice and is spaced a distance below the top surface of the ice, the light-diffusing optical fiber being configured to emit light visible at the top surface of the ice.

According to some implementations an ice rink is provided that comprises a plurality of coolant tubes located on or inside a structure having a top surface, the structure having a length and comprising a channel having a top open end located at the top surface of the structure, the channel having sidewalls and a bottom wall, the bottom wall being located a distance below the top surface of the structure. Ice is disposed above the top surface of the structure and the plurality of coolant tubes are configured to transport a coolant to cool the ice. An elongate light-diffusing optical fiber is arranged inside the channel, the light-diffusing optical fiber being configured to emit light to the top surface of the ice.

These and other advantages and features will become evident in view of the drawings and detailed description.

### BRIEF DESCRIPTION OF THE DRAWINGS

FIGS. 1A and 1B respectively show a side view and cross-section view of a light diffusing optical fiber according to one implementation;

FIG. 2 illustrates a hockey rink having light diffusing optical fibers disposed below the surface of ice and configured to define the goal lines, blue lines, centerline, end zone face off circles, center ice faceoff circle and goal box when illuminated;

FIG. 3 illustrates a speed skating rink having light diffusing optical fibers disposed below the surface of the ice and configured to define a line that separates the lanes of the rink when the optical fibers are illuminated;

FIGS. 4A-C illustrate a cross-section view of light diffusing optical fibers disposed below the surface of the ice according to some implementations;

FIGS. 5A-C illustrate cross-section views of a light diffusing optical fiber disposed in a fiber support located on a cooling platform of an ice rink according to some implementations;

FIG. 5D illustrates a cross-section view of a light diffusing optical fiber disposed in a fiber support with the fiber support resting on an thermal insulator located on the cooling platform of the ice rink;

FIG. 5E illustrates a cross-section view of a light diffusing optical fiber disposed in a fiber support located inside a channel of cooling platform of an ice rink;

FIG. 5F illustrates a cross-section view of a light diffusing optical fiber disposed in a fiber support located suspended in the ice of an ice rink;

FIGS. 6A and 6B illustrate a cross-section view of a light diffusing optical fiber disposed in a fiber support having a triangular-like shaped reflector;

FIGS. 7A and 7B illustrate a cross-section view of a light diffusing optical fiber disposed in a fiber support having a semi-circular or parabolic shaped reflector;

FIGS. 8A and 8B illustrate a plurality of light diffusing optical fibers being disposed inside a fiber support similar to the fiber support shown in FIGS. 7A and 7B;

FIGS. 9A and 9B illustrate an arrangement similar to that shown in FIGS. 7A and 7B with the fiber support having a protuberance residing in a groove located in the surface of the cooling platform of the ice rink;

FIGS. 10A and 10B illustrate a plurality of light diffusing optical fibers being disposed inside a fiber support similar to the fiber support shown in FIGS. 6A and 6B;

FIGS. 11A and 11B illustrate an arrangement similar to that shown in FIGS. 10A and 10B with the fiber support having a protuberance residing in a groove located in the surface of the cooling platform of the ice rink;

FIG. 12A illustrates a light diffusing optical fiber being support inside an enclosure located on the top surface of a cooling platform of an ice rink;

FIG. 12B illustrates a perspective view of a portion of the fiber and enclosure shown in FIG. 12A.

### DETAILED DESCRIPTION

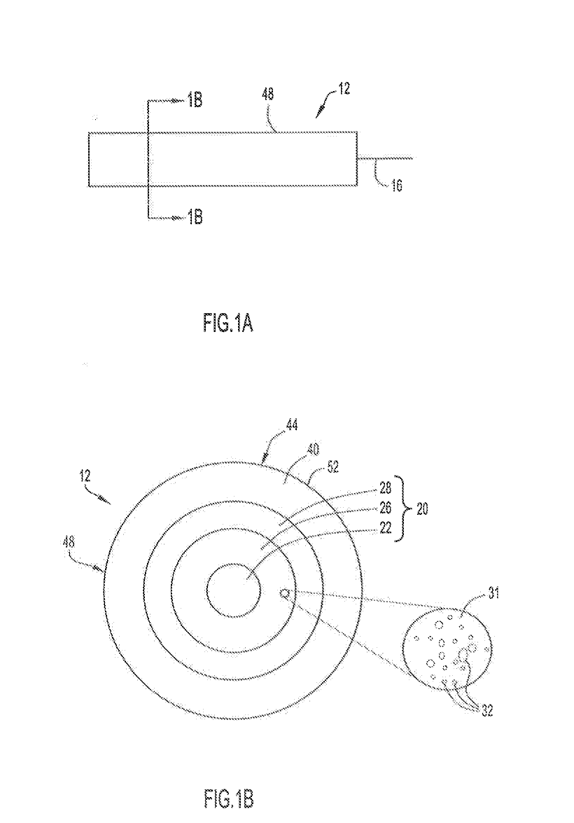

FIG. 1A is a schematic side view of a section of an example of a light diffusing fiber with a plurality of voids in the core of the light diffusing optical fiber 12 having a central axis 16. FIG. 1B is a schematic cross-section of a light diffusing optical fiber 12 as viewed along the direction 1B-1B in FIG. 1A. Light diffusing fiber 12 can be, for example, an optical fiber with a nano-structured fiber region having periodic or non-periodic nano-sized structures 32 (for example voids). In an example implementation, fiber 12 includes a core 20 divided into three sections or regions. These core regions are: a solid central portion 22, a nano-structured ring portion (inner annular core region) 26, and outer, solid portion 28 surrounding the inner annular core region 26. A cladding region 40 surrounds the annular core 20 and has an outer surface. The cladding 40 may have low refractive index to provide a high numerical aperture. The cladding 40 can be, for example, a low index polymer such as UV or thermally curable fluoroacrylate or silicone.

An optional coating 44 surrounds the cladding 40. Coating 44 may include a low modulus primary coating layer and a high modulus secondary coating layer. In at least some implementations, coating layer 44 comprises a polymer coating such as an acrylate-based or silicone based polymer. In at least some implementations, the coating has a constant diameter along the length of the fiber.

In other exemplary embodiments described below, coating 44 is designed to enhance the distribution and/or the nature of radiated light that passes from core 20 through cladding 40. The outer surface of the cladding 40 or the of the outer of optional coating 44 represents the sides 48 of fiber 12 through which light traveling in the fiber is made to exit via scattering, as described herein.

A protective jacket (not shown) optionally covers the cladding 40.

In some implementations, the core region 26 of light diffusing fiber 12 comprises a glass matrix 31 with a plurality of non-periodically disposed nano-sized structures (e.g., voids) 32 situated therein, such as the example voids shown in detail in the magnified inset of FIG. 1B. In another example implementation, voids 32 may be periodically disposed, such as in a photonic crystal optical fiber, wherein the voids may have diameters between about 1×10⁻⁶ m and 1×10⁻⁵ m. Voids 32 may also be non-periodically or randomly disposed. In some exemplary implementations, glass 31 in region 26 is fluorine-doped silica, while in other implementations the glass may be an undoped pure silica.

The nano-sized structures 32 scatter the light away from the core 20 and toward the outer surface of the fiber. The scattered light is then diffused through the outer surface of the fiber 12 to provide the desired illumination. That is, most of the light is diffused (via scattering) through the sides of the fiber 12, along the fiber length.

According to some implementations the core 20 has a diameter in the range of 125-300 μm and the overall diameter of the fiber system, including the protective jacket, is in the range of 0.7 to 1.2 mm.

A detailed description of exemplary light diffusing optical fibers may be found in Reissue Patent No. RE46,098 whose content is incorporated herein by reference in its entirety.

As noted above, the present disclosure relates to illuminating an ice rink, such as a figure skating rink, speed skating rink, hockey rink, etc. Hockey rinks typical include multiple layers ice. A first 1/32″ thick layer of ice is typically initially formed on a concrete floor having cooling pipes embedded therein. A second 1/32″ thick layer of ice is then formed on top of the first layer. The top surface of the second layer of ice is then painted white allowing for a strong contrast between the black hockey puck and the ice. A 1/16″ thick third layer of ice is then formed over the second layer of ice. The third layer acts as a sealer for the white paint. The top surface of the third layer of ice is then painted with hockey markings (the lines, creases, face-off spots and circles) and team logos. Thereafter additional layers of ice are formed one on top of the other to provide an overall ice thickness of generally between 0.75 inches to 1 inch.

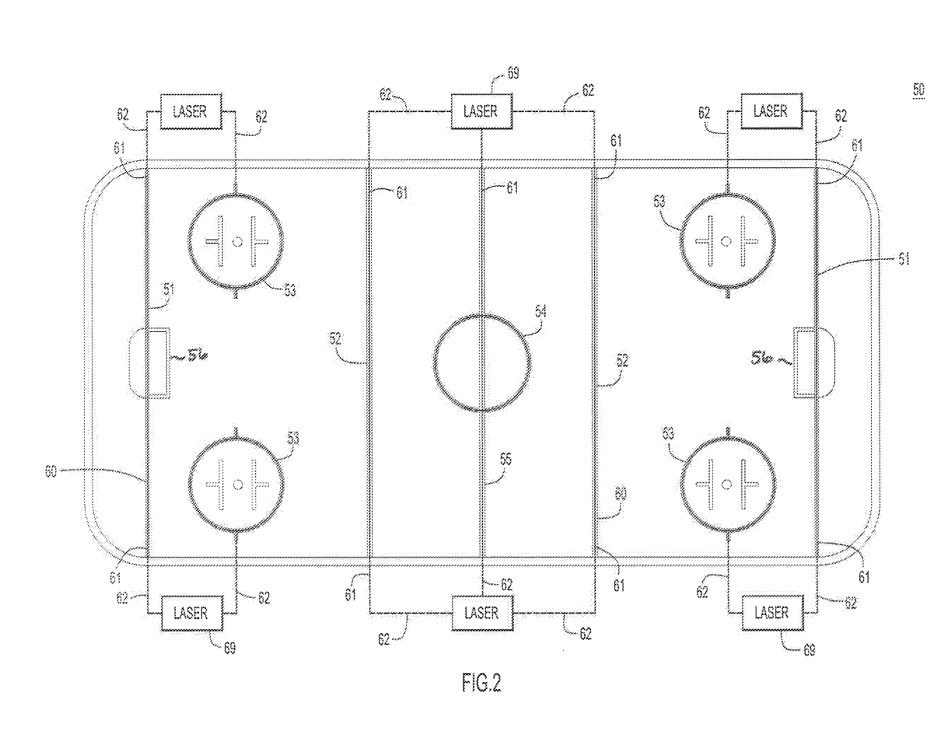

FIG. 2 shows a hockey rink 50 that uses light diffusing optical fibers 60 disposed below the surface of ice that when illuminated define the goal lines 51, blue lines 52, end zone face off circles 53, center ice faceoff circle 54, centerline 55 and goal box lines 56, thus eliminating the need to paint these lines on the ice. Examples of how the light diffusing optical fiber may be incorporated into the ice rink will be explained in detail below. The light diffusing optical fiber 60 is installed below the top surface of the ice so that light emitted by the fiber is visible from the top surface. In the example of FIG. 2 there is provided one fiber 60 for each of the goal lines 51, blue lines 52, end zone face off circles 53, center ice faceoff circle 54 and centerline 55. It is appreciated that more or fewer fibers may be used. For example, more fibers of a shorter length may be used. By shortening the length of the fibers the illumination intensity produced by the fibers can be increased.

In the implementation of FIG. 2 each end 61 of the fibers 60 that define the end lines 51, blue lines 52 and centerline 55 is light coupled to a laser source 69 so that light is delivered to the fibers from both ends. According to other implementations only one end of the fiber is connected to a laser source 69. The coupling of both ends of the fiber 60 to a light source assist in providing a more uniform and more intense illumination along the length of the fiber. The laser source 69 may be a multimode or a single mode laser diode. According to some implementations the laser source 69 is configured to emit light visible to the human eye and/or is configured to emit light that is not visible to the human eye, such as for example, infrared light. In such a case the fibers 60 may be visible only by use of a special camera that displays the emitted light to, for example, to television viewers and/or virtual and augmented reality devices users.

According to one implementation the ice rink comprises light diffusing optical fibers that emit both light visible to the human eye and also infrared light. In such an instance the fibers that illuminate visible light may be used to illuminate some or all of the lines that define a hockey rink. The fibers that emit infrared light may be used to convey words or graphics that are visible only to cameras capable of visualizing the infrared light. In this way a team logo, words, or any of a host of other illustrations may be illuminated during a game for the viewer's enjoyment without causing a distraction to the players on the rink. According to one implementation the goal lines 51 and/or goal box lines 56 are capable of being illuminated by a fiber 60 that is optically coupled to an infrared laser source with the laser source being coupled to a controller or switch that causes the laser source to emit infrared light when a goal is made. According to another implementation the goal lines 51 and/or goal box lines 56 are capable of being illuminated by a fiber 60 that is optically coupled to a laser source that emits light visible to the human eye with the laser source being coupled to a controller or switch that causes the laser source to emit visible light when a goal is made.

According to some implementations the laser source 69 may be capable of emitting a single color of light. According to other implementations the laser source is capable of emitting multiple colors of light with, for example, the use of a RGB laser module.

The laser sources 69 are preferably located a distance away from the ice rink so that heat dissipated by the laser sources have no thermal impact on the ice. Transport optical fibers (non-radially emitting) 62 may be used to couple the laser sources 69 to the light diffusing fiber 60s to optimize the delivery of light to the end(s) 61 of the light diffusing fibers 60 with little loss light. As will be discussed in more detail below, in light diffusing optical fiber systems power consumption occurs at the laser source and not in the fiber itself. As a result, a significant portion of the heat dissipation generated in the system occurs at the laser source and its associated control circuitry.

In the hockey rink example of FIG. 2 the lighting provided by the light diffusing optical fibers 60 may be used for aesthetic or entertaining purposes or may be used to assist in the regulation of the game. For entertainment purposes the fibers may be illuminated each time a goal is made. In such an event, as explained above, the fibers may emit a light that is only visible to cameras that provide a video feed to home viewers in order to prevent a distraction to the players.

According to one implementation some or all of the fibers 60 are illuminated red at the end of each period of a game. This may assist referees in the regulation of the game. In such an implementation the laser sources 69 may include a control circuit that is configured to cause a laser to illuminate one or more of the fibers 60 upon the control circuit receiving a signal indicative of a game clock expiring. According to one implementation the signal is received in the control circuit of the laser sources 69 directly from the game clock, whereas in another implementation the signal is received in the control circuit of the laser sources 69 from a controller that is operatively coupled to the game clock. According to some implementations the laser sources 69 contain one or more RGB lasers that are capable of producing in the fibers 60 a host of different light colors, including both red and blue light.

Due to the flexibility of the light diffusing fiber 60, it can be manipulated to assume a variety of shapes and may therefore be implanted in an ice rink to display any of a variety of shapes for use in producing lettering, illustrations and the like. For example, the fibers may be arranged inside an athletic court flooring to display a team logo and/or slogan as mentioned above.

As discussed above, according to some implementations the light diffusing optical fibers 60 can be used to partially or fully replace the painted lines that define a hockey rink, the tracks of a speed skating rink, etc.

Using light diffusing optical fibers provides several advantages over traditional lighting solutions such as incandescent bulbs, fluorescent bulbs and light-emitting diodes (LEDs). Each of these traditional lighting solutions produce a moderate to a significant amount of heat that will result in a melting of the ice if implanted into an ice rink. Incandescent and fluorescent bulbs are rigid structures that are easily breakable. A problem with using a string of LEDs is light produced along the length of the LED string is not uniform. That is, the gap between each of the LEDs is readily recognizable when the LEDs are illuminated. LEDs are also directional light sources that emit light in a specific direction. Light diffusing optical fibers, on the other hand, generate essentially no heat, are flexible and can emit substantially uniform and omnidirectional radiation over its length. Light diffusing optical fibers also have a much smaller cross-sectional profile that permit them to be implanted in ice without significantly disrupting the structural integrity of the ice. In addition, because light diffusing optical fibers can emit omnidirectional light they are particularly compatible with the use of reflectors that can be used to produce a desired illumination profile at the surface of the ice in which they are embedded. For example, reflectors may be deployed at least partially around the light diffusing optical fiber to produce a desired illumination width at the surface of the ice. Moreover, light diffusing optical fibers have a long length capability with lengths of up to 50 meters or more.

Other important distinctions between a string of LEDs and a light diffusing fiber are 1) the width of a string of LEDs is generally at least 5 to 10 times the width of a light diffusing optical fiber, and 2) LEDs locally emit a significant amount of heat which can be in the range of between 4.0 to 7.5 watts/meter, whereas no power consumption occurs inside the light diffusing optical fiber. In light diffusing optical fiber applications almost all of the power consumption occurs at the laser source 69 which can advantageously be located remotely from the ice rink to be lit. The amount of heat dissipated by a string of LEDs alone makes them impractical for being embedded in ice rinks since it would result in localized melting of the ice adjacent to each of the LEDs.

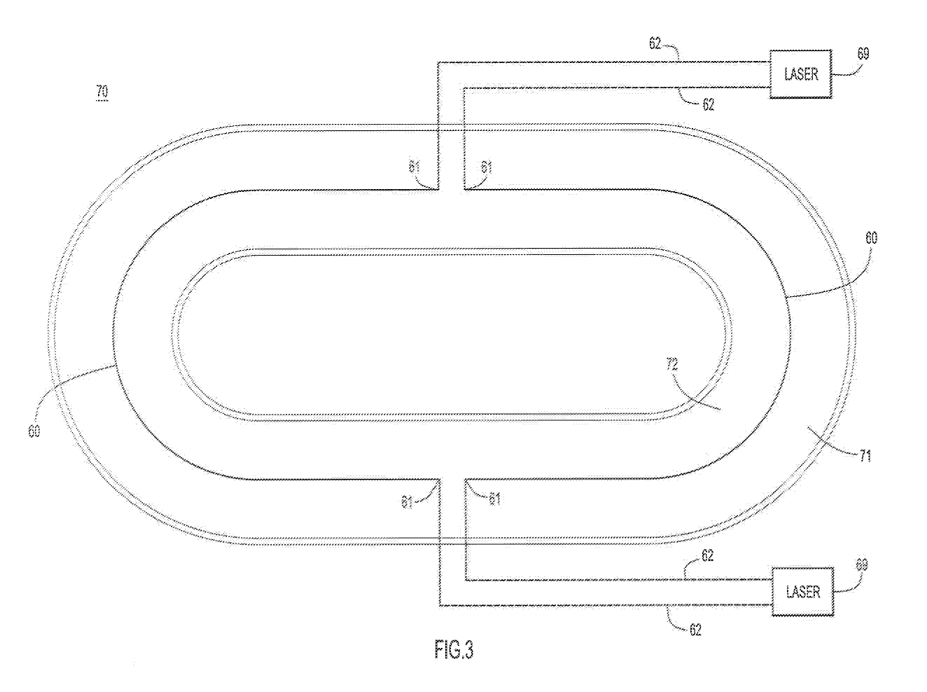

FIG. 3 illustrates a speed skating rink 70 having a first lane 71 and a second lane 72 according to one implementation. The first and second lanes are divided by two light diffusing optical fibers 60 located below the top surface of the ice with each spanning half the length of the track. It is appreciated that a single optical fiber or more than two optical fibers may also be used. In the implementation of FIG. 3 each end 61 of the optical fibers 60 is coupled to a laser source 69, although it is appreciated that only one end of the optical fiber may be coupled to a laser source.

According to some implementations a plurality of the optical fibers are dispersed in the ice rink so that they may be selectively illuminated to define different track configurations. For example, the laser sources and plurality of fibers may be configured to produce a speed skating rink that has either two lanes, three lanes, four lanes, etc. According to some implementations a plurality of light diffusing fibers are laid out below the ice surface to define a lane that runs around the rink. The light diffusing optical fibers may be caused to sequentially illuminate as a skater moves around the rink. In such an implementation a motion detector located on or off the skater may be used in conjunction with one or more controllers to control the fiber laser sources to cause the sequential lighting effect.

In figure skating rinks light diffusing optical fibers disposed beneath the surface of the ice may be configured to produce any of a variety of light forms. The light forms may define, for example, one or more theatrical venues inside the ice rink. The fibers 60 may also be laid out to at least partially follow the path a figure skater takes when performing a particular routine. For example, the fibers 60 may be laid out and configured with their light sources to illuminate as a figure skater follows a designated path on the surface of the ice. Controllers associated with the laser sources 69 may be used in conjunction with a motion sensor located on or off the figure skater to cause the turning on and off the of the laser sources 69 coupled to the fibers 60 as the skater moves about the rink.

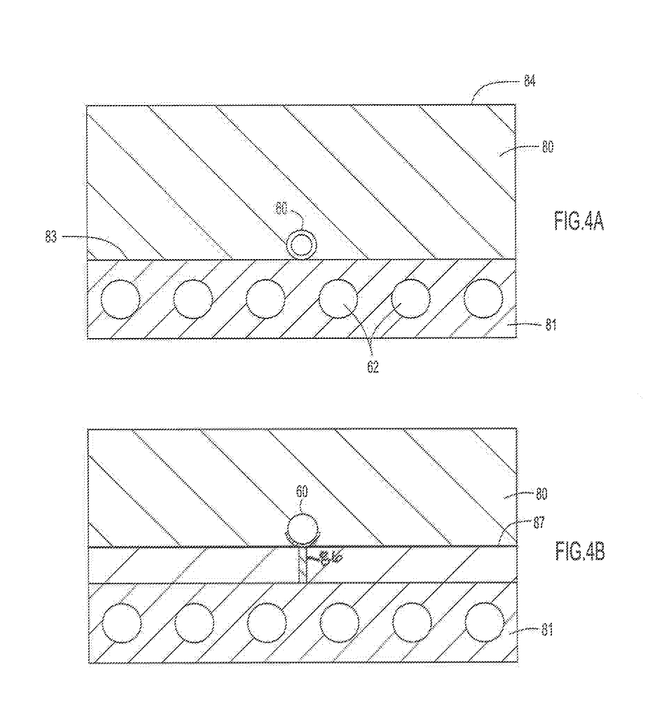

FIG. 4-12 illustrate a variety of examples for incorporating a light diffusing optical fiber into an ice rink. It is important to note that the figures are not to scale.

FIG. 4A shows a block of ice 80 formed over the top surface 83 of a substrate 81 that includes located therein a plurality of cooling tubes 82 that are used to cool the ice. A light diffusing optical fiber 60 is located adjacent the top surface 83 of the substrate 81 and is at least partially embedded in the ice 80. According to some implementations the light diffusing optical fiber 60 rests directly on the top surface 83 of the substrate 81, while in other implementations the fiber 60 is suspended above the top surface 83 by use of a pedestal 86 or other support structure as shown in FIG. 4B.

As explained above, in regard to hockey rinks a layer of white paint is typically provided to span the entire surface of the rink to provide good contrast with the black hockey puck. Traditionally the white paint layer is disposed on an ice layer 1/16″ (0.0625 inches) above the substrate 81. As further explained above, the light diffusing optical fiber may have a diameter of between 0.7 to 1.2 mm (0.028 to 0.047 inches). Thus, in an implementation consistent with that shown in FIG. 4 the top surface of the fiber 60 would reside below the painted white surface of the ice. For this reason, according to one implementation a white surface that provides contrast with the hockey puck is provided on the top surface 83 of the substrate 80 instead of being provided on a layer of the ice. As a result of the white surface being located below the optical fibers 60, it does not impede propagation of light emitted by the fiber 60 to the top surface 84 of the ice 80.

An alternative solution is to provide a white paint layer inside the ice as it is presently done with the exception that a mask is provided on the surface of the ice layer prior to it being painted. The mask would be situated on the ice above the location of the fibers 60 so that the ice directly above the fibers remain paint free when the painting process is complete. The mask is subsequently removed after the painting process.

Another solution is shown in FIG. 4B where the light diffusing optical fiber 60 is supported on a pedestal 86 so that at least a portion of the fiber resides above the painted white surface 87. According to one implementation the surface of the pedestal on which the fiber 60 rests is a reflective surface to the light emitted by the fiber. The reflective surface is configured to reflect light emitted by the fiber upward toward the top surface 84 of the ice 80.

The implementation of FIG. 4C is similar to that of FIG. 4A except the fiber 60 rests on a light reflector 88 that reflects light emitted by the fiber upward toward the top surface 84 of the ice 80.

FIG. 4D illustrates an ice rink configuration where the cooling conduits 62″ are located on or adjacent the top surface 83″ of a substrate 81″ in direct contact with the ice 80. According to one implementation, as shown in FIG. 4D, the light diffusing optical fiber 60 is also located on or adjacent the top surface 83″ of the substrate 81″. The optical fiber 60 may be supported above the top surface 83″ of the substrate 81″ by a pedestal like in the implementation of FIG. 4B, a reflector like that of implementation of FIG. 4C, or by any of a variety of the exemplary fiber supports like those discussed in detail below.

In an implementation like that of FIG. 4D with the cooling conduits in direct contact with the ice, the thickness of the ice may be greater as compared to implementations where the cooling conduits are located in the substrate as in FIGS. 4A-C. In such a case, according to one implementation one or more ice layers are formed until the top of the ice resides slightly above the top-most part of the cooling conduits, the top of the ice residing, for example, 1/32″ above the top-most part of the cooling conduits. The resulting top surface of the ice is then painted white in the manner described above. Thereafter the remainder of the ice is formed consistent with that described above.

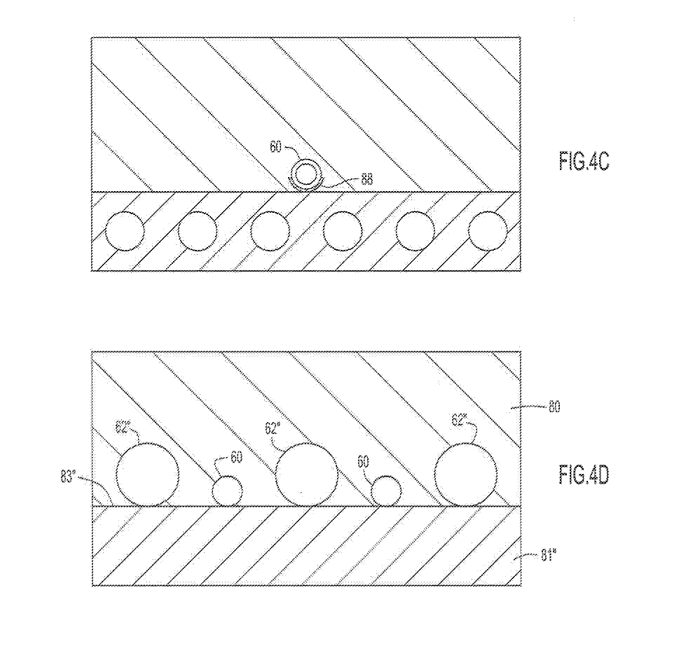

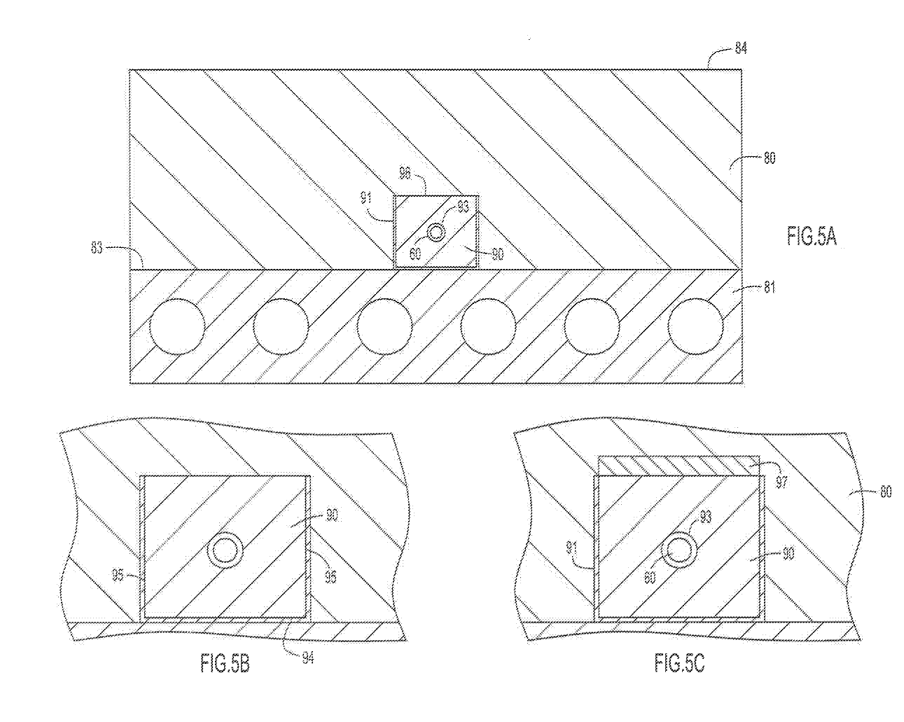

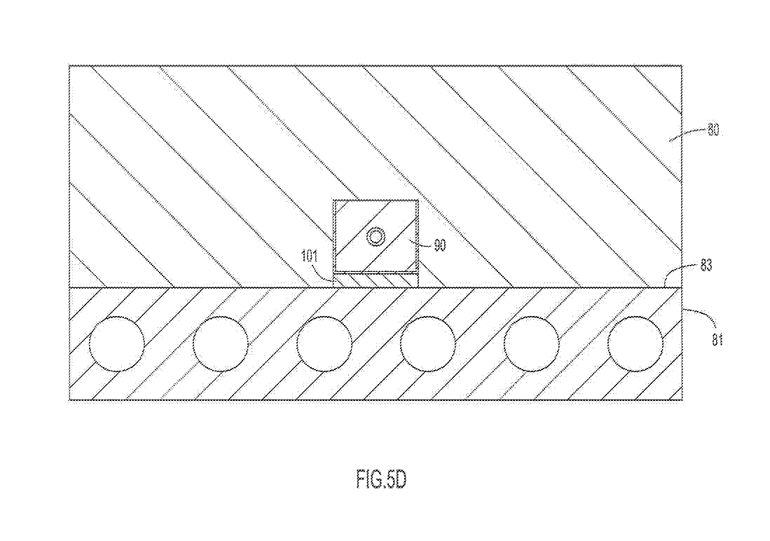

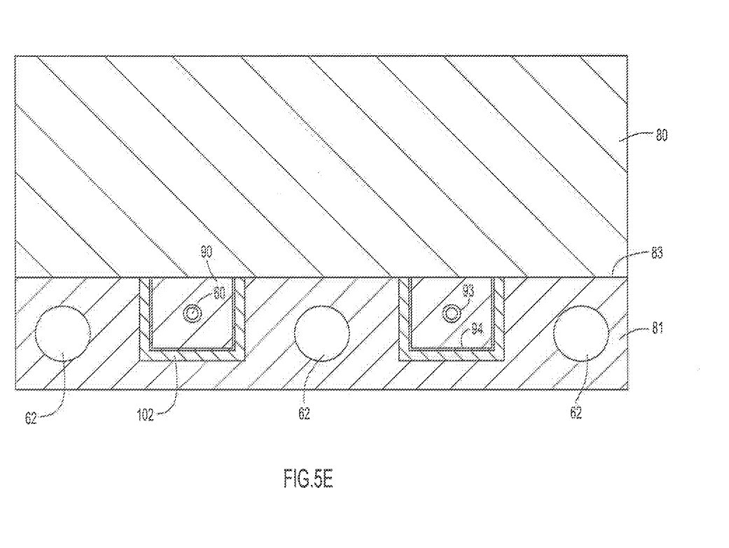

In the implementations of FIGS. 5A-D and 5F, the light diffusing optical fiber 60 is supported above the top surface 83 of the substrate 81 by use of a fiber support 90 that is transparent or translucent to the light emitted by the fiber 60. The fiber support 90 has an aperture 93 that runs along a length or the entire length of the support. In the implementations of FIGS. 5A-F the aperture is shown having a greater cross-section or diameter than the cross-section or diameter of the fiber 60. This allows the fiber 60 to be readily introduced or withdrawn from the fiber support 90. The fiber 60 can therefore be removed from the support and replaced with a new or different fiber if the fiber breaks or when an updated or improved fiber becomes commercially available. To facilitate the insertion and removal of the fiber 60 one or both of the outer-most surface of the fiber 60 and/or inner surface of the aperture 93 may possess a lubricous coating that is at least partially transparent to the light emitted by the fiber.

In the implementations shown in the figures, each of the fiber supports 90 have one or more apertures 93 that houses a single light diffusing optical fiber 60. However, according to other implementations the aperture 93 may be sized to accommodate two or more fibers. The multiple fibers may be illuminated together to produce a desired lighting effect at the surface of the ice. Alternatively, not all the fibers are used at once for illumination and the extra fiber(s) are there to be used in the event another fiber breaks or fails.

As discussed above, the light diffusing optical fiber may comprise a glass core. The glass core is susceptible to breaking when stressed. By making the diameter of the aperture 93 greater than the diameter of the outer-most surface of the fiber 60, the fiber support 90 can sustain a greater degree of deformation without harming the fiber 60 as compared to a fiber support having an aperture that has substantially the same cross-section as the fiber 60. According to some implementations the cross-sectional area of the aperture 93 is between 5 to 25 percent greater than the cross-sectional area of the fiber 60. According to other implementations the fiber 60 is embedded in the fiber support 90 so that the outer surface of the fiber jacket is flush with the inner surface of the aperture 93.

In the implementations of FIG. 5A-F a light reflector 91 that surrounds at least a portion of the fiber 60 is provided. As explained above, according to some implementations the fiber 60 emits light from all sides of the fiber. In order to scatter light emitted from the bottom and side surfaces of the fiber 60 toward the top surface 84 of the ice 80, one or more of the bottom surface 94 and side surfaces 95 of the fiber support 90 may be coated with a light reflective coating, such as, for example, a light reflective paint. Light passes from the optical fiber 60 and reflective surfaces to the top surface 84 of the ice 80 through the top surface 96 of the fiber support 90. In lieu of coating the sides of the fiber support with a light reflective coating, one or more of the bottom and side surfaces 94 and 95 of the fiber support 90 may be covered by one or more substrates that are capable of reflecting light emitted by the fiber. The one or more substrates may be affixed to one or more of the bottom and side surfaces 94, 95 of the fiber support 90. The one or more substrates may comprise mirrors, polished metallic panels, or any other structure capable of reflecting light emitted by the fiber 60.

In regard to each of the configurations disclosed and contemplated herein, a light diffuser 97 may be disposed between the fiber support 90 and the top surface 84 of the ice 80 inside which the light diffusing optical fiber 60 is positioned in a manner like that shown in FIG. 5C. The light diffuser 97 acts to scatter light generated by the optical fiber to provide a more uniform illumination along the top surface 96 of the fiber support 90 and/or the top surface 84 of the ice 80 as viewed by the human eye. The light diffuser 87 may be a block of material or a film (e.g., polymeric film). The light diffuser 97 may comprise any of a number of materials, including but not limited to an acrylic, a polycarbonate, a glass, etc. The use of a light diffuser assists in enabling the very small diameter optical fiber to effectively illuminate across a desired width along the top surface 84 of the ice 80. For example one, two or three optical fibers having a width of approximately 0.7 to 1.2 millimeters may be used to illuminate a 2 inch wide area to define the goal line of a hockey rink. In the foregoing example, the optical fiber 60 illuminates red. The same may be done to produce lines of regulation width and color for the remaining set of lines that define the hocking rink.

According to some implementations the fiber support 90 itself is made of a light diffusing material so that light generated by the optical fiber 60 is more uniformly dispersed along the top surface 96 of the fiber support 90 and/or top surface 84 of the ice as compared to a fiber support that is substantially transparent to the light emitted by the optical fiber. In such implementations the use of a separate light diffuser 97 may not be necessary.

When a light diffuser 97 is used the fiber support 90 may be made of a material that is substantially transparent to the light emitted by the optical fiber 60. According to other implementations the light diffuser 97 is used in conjunction with a fiber support that is made at least in part of a light diffusing material.

In regard to each of the configurations disclosed and contemplated herein, the fiber support 90 may possess more than one fiber 60. Thus, according to the concepts disclosed herein, one or more of: the number of fibers, dimensions of the fiber support, shape of the fiber support, transparency property of the fiber support, the distance of the optical fiber from the top surface of the ice, the location of the optical fiber inside fiber support, the use of a light diffuser, and use of a reflector are selected to create an illuminated line of a desired width at the top surface 84 of the ice 80. According to some implementations the light diffusing optical fiber 60 is substantially centrally located inside the fiber support 80. According to other implementations the light diffusing optical fiber 60 is located nearer the top surface 96 of the fiber support 90 than to the bottom of the fiber support. According to yet other implementations the light diffusing optical fiber 60 is located nearer the bottom of the fiber support 90 than to the top of the fiber support.

FIG. 5D illustrates a light diffusing optical fiber 60 being located in the ice 80 of an ice rink, the optical fiber being supported therein by a fiber support 90 like those described above with the exception that the bottom of the fiber support does not rest directly on the top surface 83 of the substrate 81, but rather is supported on a thermal insulator 101. The thermal insulator 101, at least partially insulates the optical fiber 60 from the top surface 83 of the substrate 81. According to other implementations at least a portion of the fiber support 90 itself is made of a material resistance to heat transfer.

FIG. 5E illustrates another implementation wherein the fiber support 90 containing the light diffusing optical fiber 60 is located below the top surface 83 of the substrate 81. In some instance, as shown in FIG. 5E, the bottom surface 94 of the fiber support 90 is located below the top-most part of the cooling conduits 62. However, according to other implementations the fiber supports 90 are housed in channels formed in the top surface 83 of the substrate 81 with the bottom surface of the channels residing above the top-most portions of the cooling conduits 62. According to some implementations the top surface 83 of the substrate 81 is painted white to provide the desired contrast with the black hockey puck. According to other implementations, the ice 80 is formed in the traditional manner as explained above. As described above, in instances where the optical fibers 60 are to reside below the paint layer, during the painting process masks can be positioned over those sections of the ice where the optical fibers reside and then removed. This way optical pathways are provided between the fibers 60 and the top surface 84 of the ice 80.

According to some implementations the shape of the channels conform to the external shape of at least a portion of the fiber supports. In such instances the side wall surfaces of the channel may be painted with a light reflective paint or otherwise covered with a reflective substrate in lieu of the fiber support comprising the light reflector as disclosed above.

With continued reference to FIG. 5E, a thermal insulator 102 may optionally be positioned on at least a portion of the bottom and side surfaces 94, 95 of the fiber support 90 or the bottom and side surfaces of the reflector 91.

The implementation of FIG. 5F differs from that of FIGS. 5A-E in that the fiber support 90 is neither supported on or below the top surface 83 of the substrate 81, but is rather suspended inside the ice 80 a distance “a” above the top surface of the substrate. According to one implementation the bottom wall of the fiber support or the bottom surface of reflector is spaced 1/32″ to ½″ above the top surface 83 of the substrate 81, and more preferably between 1/32″ to ¼″ above the top surface 83 of the substrate 81.

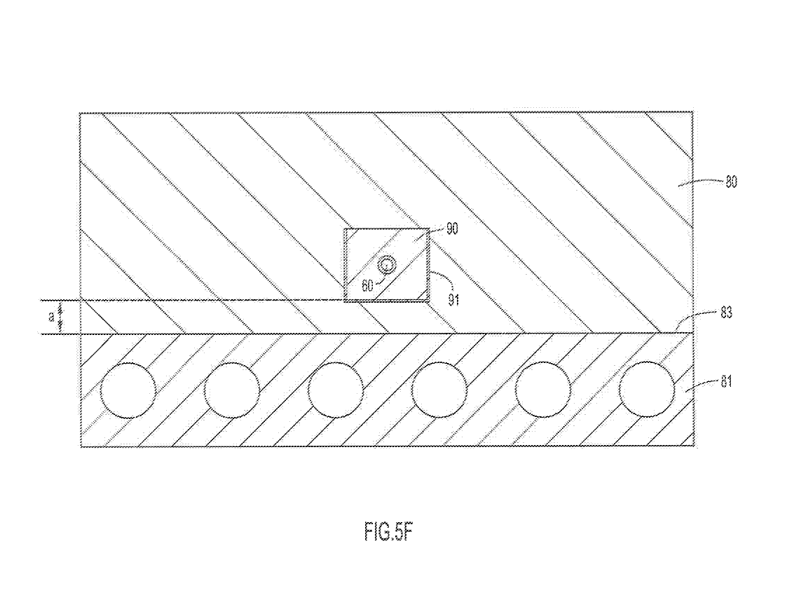

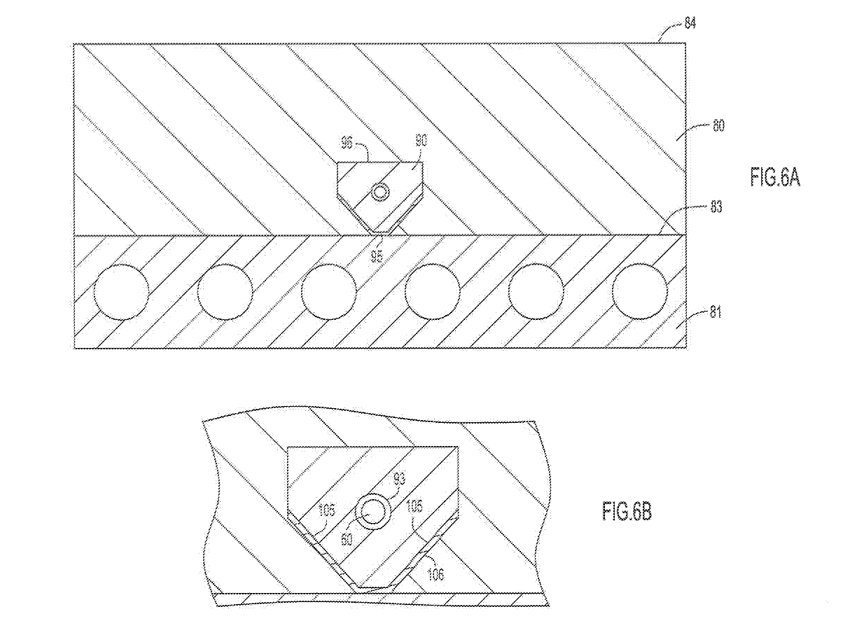

The fiber support 90 may comprise any of a number of cross-section shapes other than a rectangular shape, such as, for example, triangular-like, parabolic-like and semicircular shapes that may facilitate the scattering of light emitted by the fiber(s) toward the top surface 84 of the ice 80 in a more efficient manner. FIGS. 6A, 6B, 10A, 10B, 11A and 11B illustrate fiber supports having a triangular-like shape. FIGS. 7A-9B illustrate fiber supports having a parabolic-like shape. As will be explained below, the parabolic shaped fiber supports may be substituted with semicircular shaped fiber supports. According to some implementations a combination of two or more of the aforementioned cross-section shapes may be used. Moreover, the fiber support 90 and/or the channels that house them may possess walls having a host of different curved and straight surfaces.

In the implementation of FIGS. 6A and 6B a triangular-like shaped fiber support 90 is provided with an aperture 93 that runs at least a portion of the length or the entire length of the support. The fiber 60 may be supported inside the aperture 93 in a removable or fixed fashion like that discussed above. FIG. 6B shows the fiber as being removable by virtue of it having a smaller cross-sectional area/diameter than that of the aperture 93. The fiber support includes a base 95 from which two side surfaces 105 extend upward in a diagonal fashion. According to some implementations the base 95 and side surfaces 105 include a reflector 106 that is configured to reflect light emitted from the bottom and side surfaces of the fiber 60 upward toward the top surface 84 of the ice 80. The reflector 106 may comprise a light reflective paint, another type of light reflective coating or a reflective substrate like those described above. In the implementation shown in FIGS. 6A and 6B the bottom surface of the light reflector 106 rests on the top surface 83 of the substrate 81. Alternatively, the fiber support 90 may reside below the top surface 83 of the substrate 81 or may reside suspended in the ice 80 in a manner like that described above in conjunction with the implementations of FIGS. 5E and 5F, respectively.

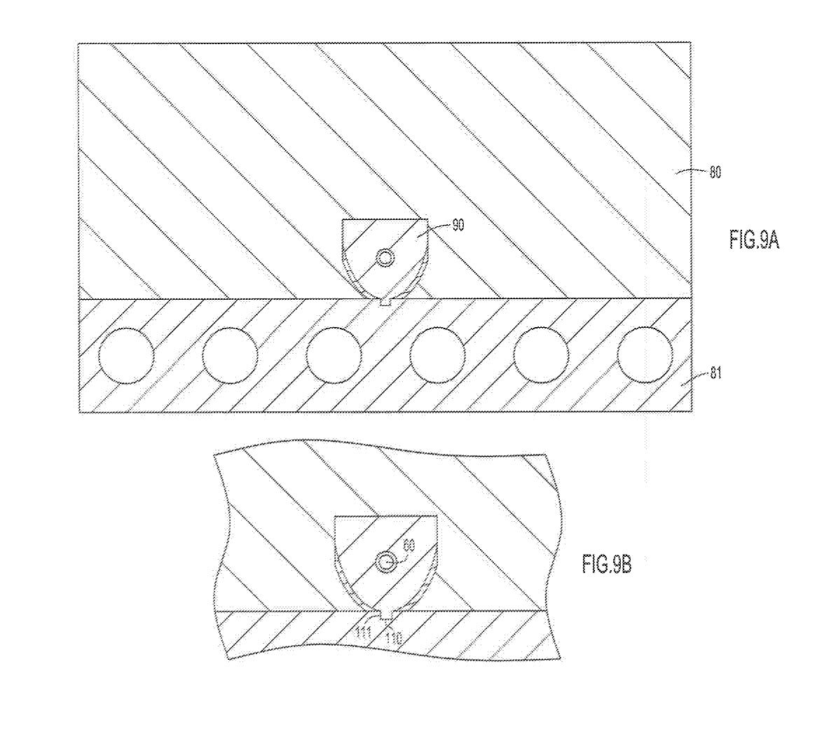

Although the figures associated with the foregoing triangular-like implementations show the use of a single fiber 60, it is appreciated that these same implementations may employ the use of multiple fibers like that shown in FIGS. 10A and 10B. FIGS. 10A and 10B illustrate an example with there being three fibers 60 positioned in three elongate apertures 93 located inside the fiber support 90.

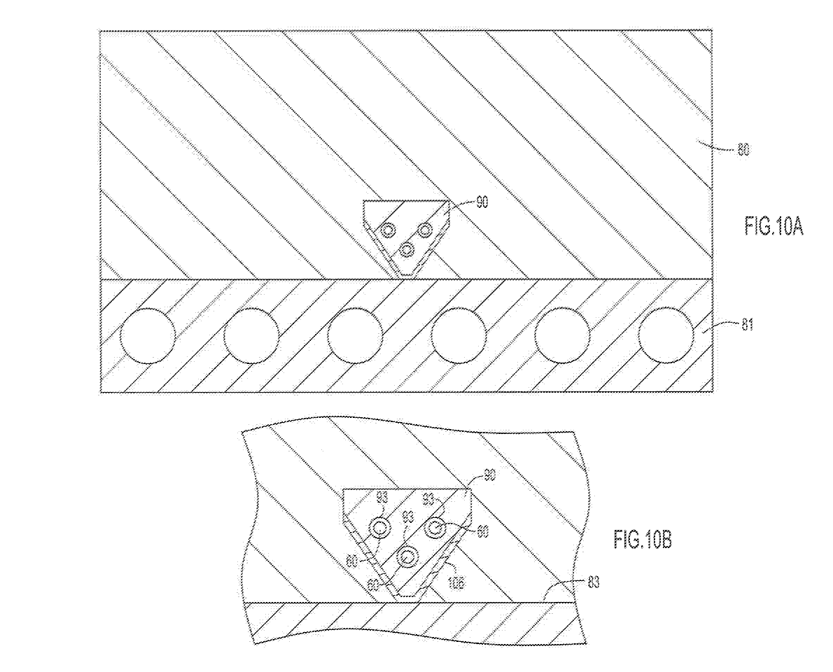

According to some implementations, like that shown in FIGS. 11A and 11B, the fiber support 90 may be aligned on or otherwise affixed to the substrate 81 by use of one or more protruding tabs 110 that are located inside a groove formed in the top surface 83 of the substrate 81. This allows the fiber supports to be fixed in location as the layers of ice that form the ice block 80 are formed. A friction fit may exist between the external surfaces of the tab(s) 110 and of the channel(s) 111 to hold the fiber support in place. In other implementations the tab(s) 110 and channels (111) have interlocking features that hold the fiber support securely in place. Alternatively, or in conjunction with these methods, an adhesive may be used to secure the tab(s) inside the channel(s).

FIGS. 7A-9B illustrate various implementation wherein which the fiber support 90 comprises a parabolic-like cross-section. In the implementation of FIGS. 7A and 7B a parabolic-like shaped fiber support 90 is provided with an aperture 93 that runs at least a portion of the length or the entire length of the support. The fiber 60 may be supported inside the aperture 93 in a removable or fixed fashion like that discussed above, although FIGS. 7A and 7B coincides with the fiber being removable by virtue of it having a smaller cross-sectional area/diameter than that of the aperture 93.

The fiber support includes a curved base 120 from which two curved side surfaces 121 extend upward. The base 120 may also be flat to enhance the stability of the support 90 on the top surface 83 of the substrate 81. According to some implementations the base 120 and side surfaces 121 include a reflector 122 that is configured to reflect light emitted from the bottom and side surfaces of the light diffusing optical fiber 60 upward toward the top surface 84 of the ice 80. The reflector 122 may comprise a light reflective paint, another type of light reflective coating or a reflective substrate like those described above.

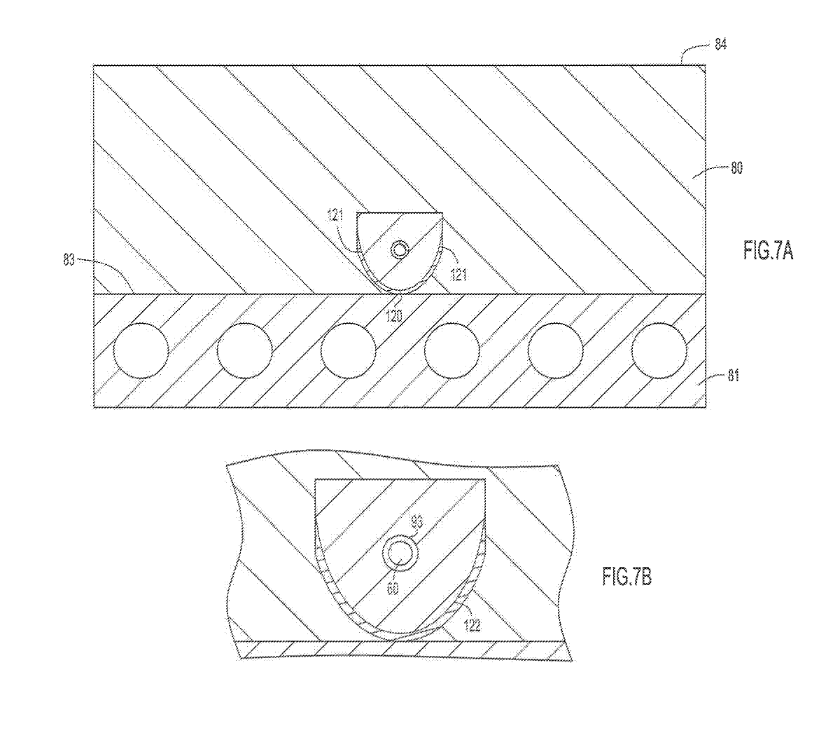

Although the figures associated with the foregoing parabolic-like implementations show the use of a single optical fiber 60, it is appreciated that these same implementations may employ the use of multiple fibers like that shown in FIGS. 8A and 8B. FIGS. 8A and 8B illustrate an example with there being three fibers 60 respectively positioned inside three apertures 93 located in the fiber support 90.

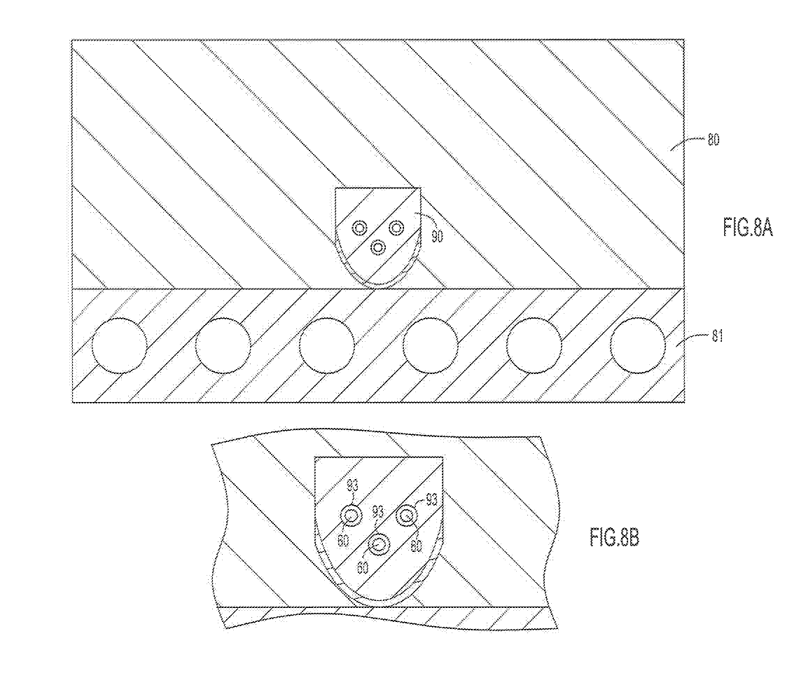

According to some implementations, like that shown in FIGS. 9A and 9B, the fiber support 90 may be aligned on or otherwise affixed to the substrate 81 by use of one or more protruding tabs 110 that are located inside a groove formed in the top surface 83 of the substrate 81. This allows the fiber support to be fixed in location as the layers of ice that form the ice block 80 are formed. A friction fit may exist between the external surfaces of the tab(s) 110 and of the channel(s) 111 to hold the fiber support in place. In other implementations the tab(s) 110 and channels (111) have interlocking features that hold the fiber support securely in place. Alternatively, or in conjunction with these methods, an adhesive may be used to secure the tab(s) inside the channel(s).

As mentioned briefly above, the fiber support may take on any of a variety of cross-sectional shapes. For example, fiber supports having a semicircular cross-sectional profile or other profiles may also be used consistent with the various examples disclosed herein.

In instances where the fiber support 90 has a non-planar base or otherwise a small planar base, a cradle having a planar base or a more substantial planar base may be used to support the fiber support on the top surface 83 of the substrate 81 to provide a more secure footing. For example, a semi-circular shaped fiber support 90 may rest inside a cradle that has a semi-circular cavity that conforms with the shape of the fiber support. The same applies to other fiber support shapes. In instances where a cradle is used, the exterior surface of the cavity that face the outer surface of the fiber support may be equipped with a light reflector like those described above, obviating the need to provide the fiber support with a light reflective surface.

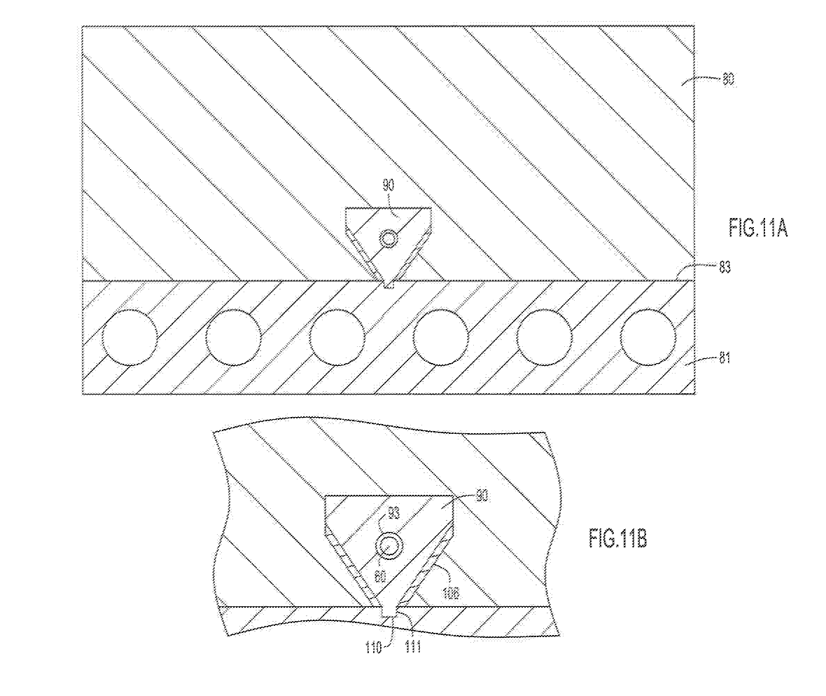

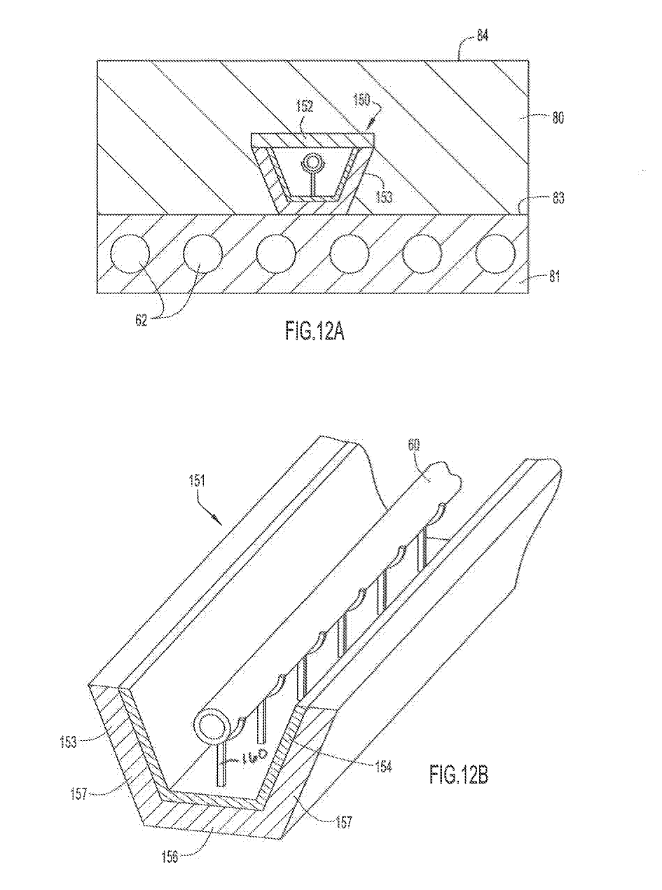

According to other implementations, like that shown in FIGS. 12A and 12B, the light diffusing optical fiber 60 resides inside a hollow housing 150 that rests on the top surface 83 of the substrate 81. According to one alternative the housing 150, or at least a portion thereof, may reside inside a channel formed in the top surface of the substrate in a manner similar to that shown in FIG. 5E. According to another alternative, the housing 150 may be suspended in the ice 80 at a location above the top surface 83 of the substrate 81 as shown in FIG. 5F.

According to some implementations the housing 150 includes a first part in the form of a trough 151, and a second part that forms a cover 152 over the trough 151. In the implementation of FIGS. 12A and 12B the trough 151 comprises an elongate body 153 having a light reflector 154 covering at least a portion of its inner surface. The light reflector 154 may comprise a layer of a light reflective coating, a polished metallic member, one or more mirrors, etc. According to some implementations the trough body 153 is made of a thermal insulating material.

In the implementation of FIGS. 12A and 12B the trough body 153 has a bottom wall 156 and two sidewalls 157 that are arranged at an angle with respect to the top surface of the ice 80. The angle of inclination of the sidewalls 157 is selected to cause light emitted by the light diffusing optical fiber 60 to be reflected upward toward the top surface 84 of the ice 80. It is appreciated that the shape of the trough body 153 and/or light reflector 154 may take on a variety of different shapes, such as, for example, a parabolic-like shape, semi-circular shape, V-shape, etc.

According to some implementations the trough is comprised of only the body that forms the light reflector 154. According to such implementations the light reflector 154 may be a folded sheet of metal having one or more light reflective surfaces that face the light diffusing optical fiber 60.

The cover 152 of the housing 150 is attached to the top of the trough body 153, preferably in a liquid-tight manner, to create an enclosure that completely surrounds the optical fiber 60. According to some implementations the cover 152 is made of a material that is transparent or translucent to the light emitted by the optical fiber 60. According to some implementations the cover 152 is made of a material that diffuses the light emitted by the optical fiber. The housing enclosure may be filled, for example, with air, and inert gas, or other gaseous medium.

According to some implementations the light diffusing optical fiber 60 is suspended inside the housing enclosure by a plurality of pedestals 160 that extend upward from the bottom of the trough. According to some implementations the optical fiber 60 is located substantially central to the housing enclosure, while in other implementations the optical fiber 60 is located nearer the top of the trough enclosure than to the bottom of the trough enclosure.

The body that forms the trough may have a one or more protruding tabs that fit into respective grooves in the top surface 83 of the substrate like that shown in FIGS. 9A, 0B, 11A and 11B.

1. An ice rink comprising:
a plurality of coolant tubes located on or inside a structure having a top surface, the structure having a length and comprising a channel having a top open end located at the top surface of the structure, the channel having sidewalls and a bottom wall, the bottom wall being located a distance below the top surface of the structure,
ice being disposed above the top surface of the structure, the plurality of coolant tubes being configured to transport a coolant to cool the ice, the ice having a top surface; and
an elongate light-diffusing optical fiber arranged inside the channel, the light-diffusing optical fiber being configured to emit light to the top surface of the ice.

2. The ice rink according to claim 1, wherein the light-diffusing optical fiber is supported in the channel a spaced distance from both the sidewalls and bottom wall of the channel.

3. The ice rink according to claim 2, wherein one or more of the sidewalls and bottom wall of the channel comprises a reflector.

4. The ice rink according to claim 3, wherein the reflector comprises a light reflective coating deposited onto the one or more of the sidewalls and bottom wall of the channel.

5. The ice rink according to claim 1 wherein an air gap exists inside the channel.

6. The ice rink according to claim 1, wherein the light-diffusing optical fiber is located inside a transparent or translucent fiber support, the fiber support comprising an outer surface, the fiber support being located inside the channel.

7. The ice rink according to claim 6, wherein an air gap exists inside the channel.

8. The ice rink according to claim 6, wherein at least a portion of the outer surface of the fiber support comprises a reflector that is configured to direct light emitted by the light-diffusing optical fiber upward toward the top surface of the ice.

9. The ice rink according to claim 8, wherein the reflector comprises a light reflective coating deposited onto the at least portion of the outer surface of the fiber support.

10. The ice rink according to claim 1, further comprising a thermal insulator located between the one or more plurality of coolant tubes and the light-diffusing optical fiber.

11. The ice rink according to claim 6, wherein the fiber support is comprised, at least in part, of a thermal insulator.

12. The ice rink according to claim 1, wherein one or more of the sidewalls and bottom wall of the channel are lined with a thermal insulator.

13. The ice rink according to claim 1, further comprising a light diffusing element disposed between the light-diffusing optical fiber and the top surface of the ice.
